(19) United States
(12) Patent Application Publication
(10) Pub. No.: US 2025/0376588 A1
(43) Pub. Date: Dec. 11, 2025

(54) BIOPOLYMER COMPOSITION AND BIOPOLYMER FILMS, SHEETS AND THEIR APPLICATIONS THEREOF

(71) Applicant: GT Origins, LLC, Boston, MA (US)

(72) Inventors: Marc Ginsburg, Gloucester, MA (US); Ravindra Gambhirsinh Thakor, Vadodara (IN)

(21) Appl. No.: 19/308,688

(22) Filed: Aug. 25, 2025

Related U.S. Application Data
(63) Continuation-in-part of application No. PCT/IN24/50199, filed on Feb. 23, 2024.

(30) Foreign Application Priority Data
Feb. 23, 2023 (IN) 202321012480
Mar. 26, 2023 (IN) 202321021632

(51) Int. Cl. C08L 67/04; C08K 3/11; C08K 3/22; C08K 11/00; C08L 67/03; C08L 75/04

(52) U.S. Cl. CPC C08L 67/04; C08K 3/11; C08K 3/22; C08K 11/00; C08L 67/03; C08L 75/04; C08K 2003/2224; C08K 2201/018

(57) ABSTRACT

The present invention relates to compostable biopolymer compositions having desirable mechanical properties, strength and transparency. The present invention also relates to compostable biopolymer films and biopolymer sheets having desirable thermoformability, flexibility, mechanical properties, reduced haze that have wide ranging applications as alternatives to single use plastics in the medical and surgical field. The compositions of the present invention are blow molded, injection molded, extruded or the polymer films or sheets comprising the biopolymer compositions may be thermoformed to prepare wide ranging single use appliances and devices.

### CROSS-REFERENCE TO RELATED APPLICATIONS

This application is a continuation-in-part of PCT Application Number PCT/IN2024/050199, filed Feb. 23, 2024, which claimed priority from India Provisional Patent Application No. 202321012480, filed Feb. 23, 2023, and India Provisional Patent Application No. 202321021632, filed Mar. 26, 2023, all of which are incorporated herein in their entirety by reference.

### TECHNICAL FIELD

The present invention relates to compostable biopolymer compositions having desirable mechanical properties, strength and transparency. The present invention also relates to compostable biopolymer films and biopolymer sheets having desirable thermoformability, flexibility, mechanical properties, reduced haze that have wide ranging applications as alternatives to single use plastics in the medical and surgical field. The compositions of the present invention can be blow molded, injection molded, extruded or the polymer films or sheets comprising the biopolymer compositions can be thermoformed to prepare wide ranging single use appliances and devices.

### BACKGROUND

Orthodontic, medical and dental appliances generally known in art are made of conventional polymer compositions that are limited by their effective modulus, flexibility, tensile strength, clarity and ability to resist creep and stress relaxation.

Further, medical and orthodontal appliances such as dental aligner materials, available in the market create microplastics which may be harmful if indigested. For example, while each aligner is processed, 40% to 60% of the waste material from each aligner fabrication ends up in a landfill as most of the grades are used in multiple combinations or layered as multilayered material which is non-degradable/non-compostable, and nonrecyclable. Due to the high rising demand for similar medical appliances and devices, there is a need for better materials which can be used to manufacture single use appliances, devices and tools which are not only superior in mechanical properties, but are also environmentally friendly and non-toxic.

WO2018222864A1, U.S. Pat. No. 9,655,691B2, U.S. Pat. No. 10,052,176B2 disclosed multilayer dental appliance composed of thermoplastic polymeric materials. Further current choice of materials in the market offers a single layer polyethylene terephthalate glycol (PET-G), thermoplastic polymeric materials like thermoplastic polyurethane (TPU), polystyrene (PS), or multilayers with different combinations of PET-G and TPU. Post usage, it is difficult to recycle or process the thermoplastic for reuse thus making such appliances and multilayer materials end up being thrown as landfill which can be detrimental to the environment.

Therefore, there is a need for an alternative to thermoplastic or petroleum-based polymeric compositions.

Attempts have been made to utilize known biopolymers as an alternative to thermoplastic polymers, however such materials are often brittle and have poor mechanical properties.

U.S. Pat. No. 10,577,494B2 (the '494 patent) patent document discloses an article such as tape or sheet comprising films composed of polylactic acid (PLA) polymer, polyvinyl acetate polymer and plasticizer such as alkyl or aliphatic esters or ether groups. The '494 patent document however discloses films having a thickness of about 10 to 500 microns which, due to low thermal resistance and processability of biopolymers such as PLA, create significant challenges in thermoforming biopolymer films or sheets of desired thickness and/or extruding or molding a medical appliance such as an aligner or article with desired mechanical strength. Orthodontic, medical and dental appliances often require multiple conflicting properties in terms of desirable mechanical properties like effective modulus, tensile stress, elasticity, flexibility and their capability to withstand creep and stress relaxation while also having a requirement to be transparent or clear. Biopolymers when extruded alone are formed in a semi-crystalline state and the resulting sheets are not flexible or thermoformable enough to form the desired medical appliances or articles. For injection molding applications, biopolymers such as PLA having a low melting point become brittle making them not suitable for such injection molding applications. One attempted solution is to add impact modifiers or plasticizers to improve the flexibility of such sheets or film, however, but that commonly results in products that are very opaque, contribute to haze which almost always end up as non-compostable.

It is generally also desirable that the medical or dental appliances exhibit resistance to staining and environmental stress cracking. However, biopolymers such as polylactic acid are susceptible to moisture and oxygen and hence also become brittle when exposed to moisture and air.

Thus there is a need to overcome the disadvantages of the prior art by providing biopolymer compositions comprising bio-based and a biopolymer films or sheets thereof which have superior mechanical properties while at the same time are clear, transparent, thermoformable, flexible and also providing for materials that are compostable and biodegradable.

### SUMMARY OF THE INVENTION

In one aspect, the present invention relates to biopolymer compositions comprising 70% to 90% by weight of polylactic acid (PLA), 0.1% to 15% by weight of a bio-based ethylene-vinyl acetate (EVA) copolymer, and 1% to 25% by weight of an impact modifier comprising a polymer of vinyl acetate. The impact modifier can be selected from a group comprising a vinyl acetate homopolymer, polyvinyl acetate vinyl laurate copolymer or a combination thereof. The biopolymer composition may optionally comprise 0% to 15% by weight of one or more bio-based polyethylene, or bio-based thermoplastic elastomer (TPE).

In a second aspect, the present invention relates to extruded biopolymer films or sheets comprising 70% to 90% by weight of polylactic acid (PLA), 0.1% to 15% by weight of a bio-based ethylene-vinyl acetate (EVA) copolymer, 1% to 25% by weight of an impact modifier comprising a polymer of vinyl acetate; and 0.01% to 15% by weight of one or more bio-based polyethylene, bio-based thermoplastic elastomer (TPE). The impact modifier can be selected from a group comprising a vinyl acetate homopolymer, polyvinyl acetate vinyl laurate copolymer or a combination thereof.

The extruded biopolymer films or sheets are thermoformable, monolayer or multilayer films or sheets having a thickness ranging from 750 microns to 1500 microns. The extruded biopolymer films or sheets are clear, compostable and flexible having a tensile stress of 35 to 85 MPa, flexural modulus of elasticity of 1200 to 3500 MPa, light transmission of 80% to 93% and haze of 0.3 to 1.2%.

In a third aspect, the present invention relates to medical or dental appliances or devices or tools made from the extruded biopolymer film or sheet.

In a fourth aspect, the present invention relates to a molded medical or dental appliance or an article comprising 70% to 90% by weight of polylactic acid (PLA), 0.1% to 15% by weight of a bio-based ethylene-vinyl acetate (EVA) copolymer, and 1% to 25% by weight of an impact modifier comprising a polymer of vinyl acetate. The impact modifier can be selected from a group comprising a vinyl acetate homopolymer, polyvinyl acetate vinyl laurate copolymer or a combination thereof.

The medical or dental appliance or article may have a thickness in the range of 0.001 mm to 20 mm. The molded appliances or articles or tools or objects are clear and compostable, have a tensile stress of 20 to 85 MPa, not brittle having a flexural modulus of elasticity of 650 to 4500 MPa, light transmission from 50% to 93%, haze of 0.3% to 1.2%, shore harness ranging A50 to D80. The molded appliance or the article can be injection molded or blow molded.

### DETAILED DESCRIPTION

The present invention includes “bio-based” polymer compositions achieving the bench mark of mechanical properties set by petroleum based polymers using instead compostable ingredients such as bio-based bio-polymer such as ethylene-vinyl acetate (EVA) copolymer, polymer of vinyl acetate, blended with compostable bio-based polyesters, like polylactic acid (PLA) and achieving the desired thermoformability and flexibility along with providing a bio-degradable and compostable clear, transparent film or sheet and further being able to be extruded or thermoformed or molded to result in appliances/devices/tools/objects for applications especially in the medical and dental fields.

The polymeric films or sheets are further useful, in medical, or dental field as they are clear and remain clear, flexible, transparent, with excellent mechanical properties due to which orthodontic appliances such as aligners, retainers can be made as commercially marketable that are desirably worn by patients.

### Definitions

In describing and claiming the invention, the following terminology will be used in accordance with the definitions set forth below. Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described herein. As used herein, each of the following terms has the meaning associated with it in this section. Specific and preferred values listed below for individual process parameters, substituents, and ranges are for illustration only; they do not exclude other defined values or other values falling within the preferred defined ranges.

As used herein, the singular forms “a,” “an,” and “the” include plural reference unless the context clearly dictates otherwise.

The term “orthodontic and dental appliance” as used herein refers to any removable apparatus positioned in or on a subject's teeth. These appliances encompass a variety of devices, including but not limited to orthodontic, prosthetic, retaining, snoring/airway, cosmetic, therapeutic, protective (e.g., mouth guards), and habit-modification devices etc.

The term “tensile stress” as used herein refers to the maximum stress that a material can withstand while being stretched or pulled before breaking.

The term “shore hardness” is used herein with reference to a measure of the resistance a material has to indentation.

The term “flexural modulus” is used herein with reference to the rigidity of a material and/or resistance of the material to stretching.

The term “compostability” is used herein with reference to the capacity of an organic material to be transformed into compost through the composting process.

The term “haze” is used herein with reference to the scattering of light by a film that results in a cloudy appearance or poorer clarity of objects that are viewed through the film.

The term “light transmission” is used herein with reference to the amount of light that can successfully pass through glass and other types of materials. Transmission is expressed through a calculated percentage of the light that can pass through the materials being tested.

The term “extrusion process” is used herein with reference to forming a film or a sheet using a single screw extrusion system keeping highest temperature of the whole processing unit in the feed zone, compression zone, melt zone, and final die temp below 200° C. to avoid over-burning of the material.

The term “injection molding” is used herein with reference to producing parts by injecting molten material into a mold.

The term “blow molding” is used herein with reference to forming hollow appliances or articles.

The term “thermoforming” is used herein with reference to the manufacturing process by which a sheet of heated plastic is forced and stretched onto the surface of a mold to create parts.

The term “film” is used herein with reference to sheets of the disclosed biopolymer compositions having thickness less than or equal to 200 microns.

The term “sheet” is used herein with reference to films having thickness more than 200 microns.

In an embodiment, the present invention provides biopolymer compositions comprising 70% to 90% of PLA that can not only be formed into an extruded film or sheet but can also be molded into desired medical or dental appliances or articles using injection molding or blow molding process. The compositions of the present invention can produce single use, compostable transparent or clear extruded films or sheets and injection or blow molded medical or dental appliances or articles with desired mechanical strength.

In one embodiment, the present invention provides biopolymer compositions that comprise 70% to 90% by weight of polylactic acid (PLA), 0.1% to 15% by weight of a bio-based ethylene-vinyl acetate (EVA) copolymer, and 1% to 25% by weight of an impact modifier comprising a polymer of vinyl acetate.

In an embodiment, the impact modifier can be selected from a group comprising a vinyl acetate homopolymer, polyvinyl acetate vinyl laurate copolymer or a combination thereof. The impact modifier is preferably in a range of 2% to 10% by weight of the biopolymer composition as disclosed.

The impact modifier can also be selected from hydrogenated styrene farnesene block copolymer (HSFC) derived from natural source. The biopolymer composition may optionally comprise one or more bio-based polyethylene, bio-based thermoplastic elastomer (TPE) in a range of 0% to 15% by weight.

The biopolymer composition may optionally comprise one or more bio-based polyethylene (PE), bio-based thermoplastic elastomer (TPE) in a range of 0% to 15% by weight. The biopolymer composition can further comprise at least one of hydrolysis additives, antioxidants and optionally natural fillers. The hydrolysis additives can be selected from carbodiimide group [—N═C═N], and the antioxidant can be selected from pentaerythritol tetrakis(3-(3,5-di-tert-butyl-4-hydroxyphenyl) propionate), tea polyphenol nanofibers.

In the present invention the bio based polymer can be selected from polylactic acid (PLA), starches, polyhydroxyalkanoates (PHA), poly butylene adipate (PBA), PBAi-poly butylene adipate ionomer, polybutylene succinate (PBS), polycaprolactone (PCL), polybutylene adipate terephthalate (PBAT), or any combinations thereof. The bio based polymer can preferably be PLA.

In the present invention the natural fillers can be selected from group comprising cellulose acetate (CA) natural fillers derived from corn, potato, sugarcane or any other bio-source.

In another embodiment, the present invention provides extruded biopolymer films or sheets comprising 70% to 90% by weight of polylactic acid (PLA), 0.1% to 15% by weight of a bio-based ethylene-vinyl acetate (EVA) copolymer, 1% to 25% by weight of an impact modifier comprising a polymer of vinyl acetate; and 0.01% to 15% by weight of one or more bio-based polyethylene, bio-based thermoplastic elastomer (TPE). The impact modifier can be selected from a group comprising a vinyl acetate homopolymer, polyvinyl acetate vinyl laurate copolymer or a combination thereof.

The extruded biopolymer film or sheet further can comprise at least one of hydrolysis additives and antioxidants. The hydrolysis additives can be selected from carbodiimide group [—N═C═N]. The antioxidant in the extruded biopolymer film can be selected from pentaerythritol tetrakis(3-(3,5-di-tert-butyl-4-hydroxyphenyl) propionate), tea polyphenol nanofibers.

In the present invention the natural fillers can be selected from group comprising cellulose acetate (CA) natural fillers derived from corn, potato, sugarcane or any other bio-source.

The extruded biopolymer films or sheets of the present invention can be thermoformable. The biopolymer films or sheets of the present invention can be thermoformed using conventional thermoforming processes and equipment without resulting in brittle products. In an embodiment, the biopolymer films or sheets can be thermoformed using single screw extrusion systems by maintaining the highest temperature of the whole processing unit in the feed zone, compression zone, melt zone, and final die temperature below 200° C. to avoid over-burning of the materials.

In an embodiment, the extruded biopolymer films or sheets can be formed as a monolayer or multilayered films or monolayer or multilayered sheets. In a preferred embodiment, the biopolymer films or sheets of the present invention can be a monolayer or multilayer film or monolayer or multilayered sheet, having a thickness in the range of 750 microns to 1500 microns. The multilayered films or multilayered sheets may have two or more than two layers.

The extruded biopolymer films or sheets can be clear, compostable or transparent, compostable and flexible.

The extruded biopolymer film or sheet of the present inventions shows desirable mechanical properties suitable for forming medical and dental appliances and/or articles.

In an embodiment, the extruded film or sheet of the present invention has a tensile stress of 35 to 85 MPa, flexural modulus of elasticity of 1200 to 3500 MPa, light transmission of 80% to 93% and haze of 0.3 to 1.2%.

The extruded biopolymer film or sheet of the present invention thus provides the desired thickness, mechanical strength and transparency (clear) while being compostable and suitable for making medical or dental appliances. Thus, the present invention also provides medical or dental appliances made from extruded biopolymer film. The dental appliances of the present invention can be orthodontic appliances made from the extruded biopolymer film.

In another embodiment, the present invention provides molded medical or dental appliances or articles or tools. The appliances or articles comprises 70% to 90% by weight of polylactic acid (PLA), 0.1% to 15% by weight of a bio-based ethylene-vinyl acetate (EVA) copolymer, and 1% to 25% by weight of an impact modifier comprising a polymer of vinyl acetate. The impact modifier can be selected from a group comprising a vinyl acetate homopolymer, polyvinyl acetate vinyl laurate copolymer or a combination thereof. The medical or dental appliance or article has a thickness of 0.001 mm to 20 mm.

The molded appliances or articles further can comprise at least one of hydrolysis additives and antioxidants and optionally natural fillers. The hydrolysis additives can be selected from carbodiimide group [—N═C═N], and the antioxidant can be selected from pentaerythritol tetrakis(3-(3,5-di-tert-butyl-4-hydroxyphenyl) propionate), tea polyphenol nanofibers.

In the present invention the natural fillers can be selected from group comprising cellulose acetate (CA) natural fillers derived from corn, potato, sugarcane or any other bio-source.

In the present invention, the polylactic acid (PLA) can be preferably selected from commercially available PLA under the respective trade name RIVODE PLA (HISUN Chemicals), LUMINEY (Corbion Chemicals), ESUNBIO2021S (ESUN Chemicals), 4032D (Nature Works LLC), BIOFLEX (FKUR).

In the present invention, the impact modifier can be preferably selected from commercially available impact modifiers under the respective trade name VINNEX® 2525 (Wacker) and VINNEX® 8880 (Wacker).

In the present invention, the bio-based ethylene-vinyl acetate (EVA) copolymer can be preferably selected from commercially available EVA under the trade name BRASKEM (FKUR) and also commercially available from EVONIC BASF.

In the present invention, the bio-based polyethylene can be preferably selected from commercially available under the trade name BIO-PE (FKUR).

In the present invention, the bio-based thermoplastic elastomer (TPE) can be preferably selected from commercially available TPE under the trade name TERRAPRENE (FKUR).

The molded appliance or the article is clear and has high mechanical strength and desired mechanical properties. It is also compostable. The molded appliance or the article can be clear, transparent or colored with gloss or matt finish. The appliance in accordance with the present invention can be compostable either by the method of home, industrial, soil, water, air or by the way of marine composting. The appliance or the article can be a single use, disposable or reusable appliance.

In an embodiment, the molded appliance or the article has a tensile stress of 20 to 85 MPa, flexural modulus of elasticity of 650 to 4500 MPa, light transmission from 50% to 93%, haze of 0.3% to 1.2%, shore harness ranging A50 to D80.

In an embodiment, the molded appliance or the article can be manufactured by conventional process of thermoforming, injection molding or blow molding using commercially available machines with variable tonnage pressure depending on the weight of the article and mold design. The molding temperature can be maintained to be not more than 200° C. Overheating the material may result in loss of desired properties in the molded article. Preferably, injection molding temperature can be in the range of 140° C. to 200° C.

The extruded biopolymer film or extruded biopolymer sheet and the molded appliance or article of the present invention showed exceptional excellent tensile strength, flexibility, flexural modulus of elasticity and transparency. The extruded films or sheets made from the biopolymer compositions of the invention showed excellent flexibility and were not brittle. The extruded film or sheet and the molded article of the present invention not only show excellent impact strength but are also able to maintain excellent transparency (clear). Light transmission experiments performed in accordance with the present invention showed haze of 0.3 to 1.2% and showed excellent transparency in films or sheets with a with a thickness of 750 microns to 1500 microns produced by extrusion process. The films or sheets and articles of the present invention are also compostable which makes the extruded biopolymer films or sheets and the molded appliance or article of the present invention as suitable alternative to the thermoplastic material.

Various molded appliances or articles can be made from the biopolymer composition of the present invention. In an embodiment, the molded appliances or articles can be an oral appliance selected from as those used as aligners such as tooth aligners, mouth guards, orthodontic retainers.

The present invention relates to appliances or articles made from the compositions according to the present invention. Specific examples of articles made from the composition can include, but are not limited to, extruded or blow films, extruded or blow sheets, thermoformed appliances or articles and injection molded or blow molded appliances or articles. Specific examples of films or sheets can include thin films or sheets, monolayer or multilayer coextruded or blown films or sheets. The molded appliance or the article can be obtained by thermoforming, extrusion blow molding, injection blow molding or injection stretch blow molding, blow film molding or any other extrusion process.

The molded medical or dental appliance or the article of the present invention can be an aspirator tip, a needle barrier/sheath combination, a local anesthetic (LA) plunger, a barrier sleeve for the aspirator, a barrier film to cover the surgical trays, or an apron, a mixing spatula, an interdental brush, a micro brush, a sectional impression tray, a full arch impression tray, cheek retractor, tongue retractor.

The molded medical or dental appliance or the article of the present invention can be a barrier sleeve for handheld portable LED curing light, an intraoral camera sleeve, a bag to carry all autoclave wipes or waste bags made by blow film process.

The molded medical or dental appliance or the article of the present invention can be a mixing tray made by made by thermoforming of sheet process.

The molded medical or dental appliance or the article of the present invention can be a surgical suction tip made by extrusion process, a medical blister pack and a blister pack for other instruments or devices made by film or sheet extrusion process.

The molded appliance or the article can be an impression material mixing tip, be a pump bottle for moisturizing lotions, a toothbrush and its handle made by injection molding process and used in dental, engineering, medical non-ICU, cosmetic, pharmacy applications.

The present invention holds the promise of revolutionizing the medical and dental care by offering compostable and bio-degradable biopolymer composition, a film or a sheet and an appliance thereof with enhanced properties with respect to a clear, transparent film or appliance and achieving excellent mechanical strength, thermoformability, flexibility, and desirable aesthetics through the integration of cutting-edge bio-based technology promoting sustainability with life cycle.

### EXAMPLES

Examples and implementations are provided herein below for the illustration of the invention. Variations, modifications, and enhancements to the described examples and implementations and other implementations can be made based on what is disclosed.

### Example 1

Table 1 shows list of the materials useful as components for the biopolymer composition.

TABLE 1
materials useful as components for the biopolymer composition

| Trade Name | Supplier's Name | Category |
|---|---|---|
| RIVODE PLA | HISUN CHEMICALS | polylactic acid (PLA) |
| LUMINEY | CORBION | polylactic acid (PLA) |
| | CHEMICALS | |
| ESUNBIO2021S | ESUN chemicals | polylactic acid (PLA) |
| 4032D | Nature works | polylactic acid (PLA) |
| BIOFLEX | FKUR | polylactic acid (PLA) |
| VINNEX ® 2525 | WACKER | impact modifier - vinyl |
| | | acetate homopolymer |
| VINNEX ® 8880 | WACKER | impact modifier - polyvinyl |
| | | acetate vinyl laurate |
| | | copolymer |
| BRASKEM | FKUR | Bio-based EVA (ethyl vinyl |
| | | acetate) |
| EVONIC BASF | EVONIC BASF | Bio-based EVA (ethyl vinyl |
| | | acetate) |
| TERRAPRENE | FKUR | Bio-based thermoplastic |
| | | elastomer (TPE) |
| BIO-PE | FKUR | Bio-based polyethylene |

### Example 2—Biopolymer Composition with Bio-Based Thermoplastic Elastomer (TPE)

Table 2 shows biopolymer composition with bio-based thermoplastic elastomer (TPE).

TABLE 2
biopolymer composition with bio-based thermoplastic elastomer

| | |
|---|---|
| polylactic acid (PLA) | 70% to 90% by weight |
| impact modifier comprising a | 1% to 25% by weight |
| polymer of vinyl acetate | i.e. 2% to 10% of a vinyl acetate |
| | homopolymer or polyvinyl acetate vinyl |
| | laurate copolymer or combination |
| bio-based ethylene-vinyl acetate | 0.1% to 15% by weight |
| (EVA) copolymer | |
| bio-based polyethylene | 0% to 15% by weight |
| bio-based thermoplastic | 0% to 15% by weight |
| elastomer (TPE) | |

Biopolymer composition is prepared by blending 70% to 90% by weight of polylactic acid (PLA), 1% to 25% by weight of an impact modifier, 0.1% to 15% by weight of a bio-based ethylene-vinyl acetate (EVA) copolymer, and optionally 0% to 15% by weight of one or more bio-based polyethylene, or 0% to 15% by weight of bio-based thermoplastic elastomer (TPE). Suitable additives selected from a group comprising at least one hydrolysis additives, antioxidants can be added to the blend if desired.

### Example 3—Biopolymer Composition without Bio-Based Thermoplastic Elastomer (TPE)

Table 3 shows biopolymer composition without bio-based thermoplastic elastomer.

TABLE 3
biopolymer composition without bio-based thermoplastic elastomer

| | |
|---|---|
| polylactic acid (PLA) | 70% to 90% by weight |
| impact modifier comprising a | 1% to 25% by weight |
| polymer of vinyl acetate | i.e. 2% to 10% of a vinyl acetate |
| | homopolymer or polyvinyl acetate vinyl |
| | laurate copolymer or combination |
| bio-based ethylene-vinyl acetate | 0.1% to 15% by weight |
| (EVA) copolymer | |
| bio-based polyethylene | 0% to 15% by weight |

Blending 70% to 90% by weight of polylactic acid (PLA), 1% to 25% by weight of an impact modifier, 0.1% to 15% by weight of a bio-based ethylene-vinyl acetate (EVA) copolymer, and 0% to 15% by weight of one or more bio-based polyethylene.

Suitable at least one hydrolysis additives, and antioxidants can be added to the blend if desired.

### Example 4—Extruded Biopolymer Film

### Example 4A—Composition of Extruded Biopolymer Film

Table 4 below shows the composition of extruded biopolymer film.

TABLE 4
Extruded biopolymer film composition

| | |
|---|---|
| polylactic acid (PLA) | 70% to 90% by weight |
| impact modifier comprising a | 1% to 25% by weight |
| polymer of vinyl acetate | i.e. 2% to 10% of a vinyl acetate |
| | homopolymer or polyvinyl acetate vinyl |
| | laurate copolymer or combination |
| bio-based ethylene-vinyl acetate | 0.1% to 15% by weight |
| (EVA) copolymer | |
| bio-based polyethylene | 0.01% to 15% by weight |

### Example 4B—Process of Forming the Extruded Films or Sheets Using the Extrusion Line

The blended biopolymer composition was formed into a film or sheets of desired thickness using a single screw extrusion system keeping highest temperature of the whole processing unit in the feed zone, compression zone, melt zone, and final die temp below 200° C. to avoid over-burning of the material.

70% to 90% by weight of polylactic acid (PLA), 0.1% to 15% by weight of a bio-based ethylene-vinyl acetate (EVA) copolymer, 1% to 25% by weight of an impact modifier comprising a polymer of vinyl acetate; and 0.01% to 15% by weight of one or more bio-based polyethylene, bio-based thermoplastic elastomer (TPE) were pre-dried using a hot air dehumidifier set at 60° C. for at least of 2 to 3 hours and was fed to the extruded with a single screw head of 50 mm Dia with the L/D ratio of the screw being 24:1 while the same can be done by using an L/D ratio of 30:1 also. Unit with L/D ratio of 24:1 was operated with minimal take-off speed until the desired flow of melted material was achieved, post the speed of the screw was gradually increased. Extruded material was wrapped around three roll calendaring unit with roll temperatures varying from 10 to 25° C. This calendaring unit was synchronized with the speed of the extrusion unit. The air gap between the die and chilled roll was maintained by a minimum of 60 to 125 mm depending on the thickness of the material being made post, material was subjected to side trill to get uniform width by passing the roll under knife rollers fixed at desired width apart.

The cut roll of material was re-heated online using a ceramic heater to make the surface temperature of the rolls come closer to 40° C. and not more than 60° C. lamination processing using commercially available LDPE lamination was done under banana rolls to avoid forming any kind of creases on surfaces of sheets or films. At the final stage, the sheets or films were measured and cut to the desired length as per requirement. Using the same extrusion setup thinner sheets or films can also be made and laminated by subjecting them under heat and pressure. Multi-layer sheets or films can be made using a 3-head co-extrusion unit where three different thickness/material layers are extruded at once and they are directly pressed under the rolls to form a union due to heat and pressure. The process can include application of heat and a pressure-activated adhesive layer in a thickness of 5 to 50 microns.

Table 5 shows the weight % of the composition and the mechanical properties of the extruded biopolymer film in accordance to the present invention.

TABLE 5
weight % of composition and mechanical properties of extruded biopolymer film

| | | | | Mechanical Properties | | | |
|---|---|---|---|---|---|---|---|
| | | | | Tensile | Flexural | | Light |
| | | | | strength | modulus | Haze | transmission |
| No. | Components | Category | Composition | (Mpa) | (Mpa) | (%) | (%) |
| 1 | RIVODE PLA | PLA | 73% | 38-50 | 1300-2000 | 1.2 | 70-80 |
| | VINNEX ® 2525 | Impact Modifier - | 2% | | | | |
| | WACKER | vinyl acetate | | | | | |
| | | homopolymer | | | | | |
| | TERRAPRENE, | TPE | 15% | | | | |
| | FKUR | | | | | | |
| | EVONIC BASF | EVA | 10% | | | | |
| 2 | LUMINEY, | PLA | 87% | 60-75 | 1750-2750 | 0.9-1.2 | 80-90 |
| | CORBION | | | | | | |
| | CHEMICALS | | | | | | |
| | VINNEX ® 8880 | Impact Modifier - | 2.5% | | | | |
| | WACKER | polyvinyl acetate | | | | | |
| | | vinyl laurate | | | | | |
| | | copolymer | | | | | |
| | BRASKEM, FKUR | EVA | 10% | | | | |
| | BIO-PE, FKUR | Bio-polyethylene | 0.5% | | | | |
| 3 | ESUNBIO2021S, | PLA | 86% | 65-75 | 1800-2750 | 0.6-1.0 | 85-90 |
| | ESUN chemicals | | | | | | |
| | VINNEX ® 2525 | Impact Modifier - | 2.5% | | | | |
| | WACKER | vinyl acetate | | | | | |
| | | homopolymer | | | | | |
| | BIO-PE, FKUR | Bio-polyethylene | 7.5% | | | | |
| | TERRAPRENE, | TPE | 4% | | | | |
| | FKUR | | | | | | |
| 4 | 4032D, Nature | PLA | 90% | 71-84 | 1750-2500 | 0.5-0.8 | 85-93 |
| | works | | | | | | |
| | VINNEX ® 2525 | Impact Modifier - | 4.5% | | | | |
| | WACKER | vinyl acetate | | | | | |
| | | homopolymer | | | | | |
| | EVONIC BASF | EVA | 5.2% | | | | |
| | BIO-PE, FKUR | Bio-polyethylene | 0.3% | | | | |
| 5 | BIOFLEX FKUR | PLA | 90% | 70-85 | 3200-3450 | 0.6-0.9 | 85-93 |
| | VINNEX ® 8880 | Impact Modifier - | 2.5% | | | | |
| | WACKER | polyvinyl acetate | | | | | |
| | | vinyl laurate | | | | | |
| | | copolymer | | | | | |
| | EVONIC BASF | EVA | 5.2% | | | | |
| | BRASKEM FKUR | EVA | 2.3% | | | | |

The extruded biopolymer film is clear and flexible having a tensile stress of 35 to 85 MPa, flexural modulus of elasticity of 1200 to 3500 MPa, light transmission of 80% to 93% and haze of 0.3 to 1.2%.

### Example 5—Process for Blow Forming of Films and Thermoforming of Objects

Blow film-All heating temperatures i.e. below 200° C. and machine specifications remain the same as Example 4. The melted material is passed along the blow film plant to get the thickness needed as all blow films are formed as a bubble of material in the thickness needed. This bubble is cut from the side and the final formed film is rolled on a three-roll auto-winding station with constant tension.

Thermoforming—The extruded sheet or films as obtained in above example 4 are used for forming thermoformed objects.

### Example 6—Preparation of the Molded Medical or Dental Appliance or an Article

Granules are pre-dried by air dryer at temperature of 60° C. They are injected using a commercially available injection molding machine with variable tonnage pressure depending on the weight of the article and mold design. They are injected by keeping the temperature of not more than 200° C. and care is taken to not overheating the material resulting as there can be in loss of properties. Safe temperature to work the injection molding are in range of 140 to 200° C.

Table 6 shows the the mechanical properties of the molded medical or dental appliance or an article in accordance to the present invention.

TABLE 6
mechanical properties of the molded medical or dental appliance

| | | | Mechanical Properties | | | | |
|---|---|---|---|---|---|---|---|
| | | | Tensile | Flexural | | Light | |
| | Article/ | Multi layer/monolayer- | strength | modulus | Haze | transmission | Shore |
| No. | appliance | film or sheet used | (Mpa) | (Mpa) | (%) | (%) | Hardness |
| 1 | Aligner | Mono layer | 65 | 3500 | 1.0 | 83% | D20 |
| 2 | Aligner | Multilayer | 55 | 3000 | 1.0 | 86% | A70 |
| 3 | Mixing | Mono layer | 85 | 4250 | 1.2% | 50% | D80 |
| | tray | | | | | | |
| 4 | Spatula | Injection molded | 85 | 4500 | 1.0% | 50% | D70 |
| 5 | Aspirator | Monolayer | 40 | 1500 | 1.0% | 80% | D30 |
| | tip | | | | | | |

The molded appliance or the article obtained is clear and compostable, has a tensile stress of 20 to 85 MPa, flexural modulus of elasticity of 650 to 4500 MPa, light transmission from 50% to 93%, haze of 0.3% to 1.2%, shore hardness ranging A50 to D80.

### Example 7—Biodegradability

The presently claimed polymer films, sheets and appliances, devices, articles all such materials based on the disclosed biopolymer compositions show a high degree of biodegradability.

As per ISO standard testing ISO 17088 2021, the biodegradability of the claimed composition-based materials showed biodegradation of more than 80% of dry mass in 120 days which was significantly better than positive threshold of the test.

### Test Methods

### 1. Tensile Stress and Flexural Modulus of Elasticity Properties

Tensile stress and Flexural modulus of elasticity properties was measured using procedures of ISO 527 tensile stress and flexural modulus of elasticity properties.

### 2. Haze and Light Transmitting—ASTM D1003

Haze and light transmission was measured using procedure as per ASTM D1003.

### 3. Compostability

Compostability of the “biopolymer films and article or appliances” were assessed using procedures of ISO 17088 2021.

### 4. Shore Hardness

Shore hardness is tested using procedures as per ISO868.

The foregoing description of specific embodiments of the present invention has been presented for purposes of illustration and description. They are not intended to be exhaustive or to limit the present invention to the precise forms disclosed, and obviously many modifications and variations are possible in light of the above teaching.

Some embodiments disclosed herein contain 0% of petroleum-based products such that each and every component introduced during the manufacturing process contains 0% petroleum-based products. Some of these embodiments are soil compostable meaning that the end products may simply be buried in the back yard after their useful life as products and they will break down naturally within two years. Other embodiments are also fully compostable but require industrial composting to complete the break down process. While less desirable, industrial composting provides similar benefits of soil composting but has further and more complex requirements and may be more difficult to achieve by everyday consumers who may, for example, simply throw out products at the end of their useful life.

Other embodiments comprise components that include essentially “As-Is” components in that they are utilized as components in essentially the same state they exist in nature with “minimal processing.” Thus, some embodiments may include talc which is a naturally occurring mineral mined from rock deposits, for example, where the minimal processing may include simply grinding and purifying the mined material into talc powder, as compared with extensive processing that is used in producing petroleum-based components. Various embodiments herein combine “As-Is” components with bio-based components to provide interim and end products in which there are no petroleum-based components (i.e., 0%). Accordingly, such products whether interim or final end products and whether they contain bio-based components, As-Is components, or a combination of bio-based and As-Is components are referred to herein as being comprised of “Naturally Occurring” components (which as defined herein specifically excludes all petroleum-based components).

In other embodiments it may be preferrable to produce compostable biopolymer compositions that are composed completely of Naturally Occurring components such that they contain no petroleum-based components while also being “naturally” compostable, in that they could, for example, simply be buried in the backyard where composting would occur without requiring industrial composting processes.

In particular, in such embodiments it may also be preferrable for material properties of such compositions to exhibit various characteristics that have the potential to be more closely aligned with, for example, regular real-life applications such as by having optical properties that better align with natural translucency or opacity and colors such as the various colors of teeth. In other instances, it may be advantageous for the material properties to go in the opposite direction such as for pediatric applications where dental devices may be fabricated from the biopolymer compositions described herein in specific colors for children to encourage use, or, for example, in contact sports applications where the entire team might utilize products such as mouth guards fabricated to exhibit the team's colors. In still other applications, the present biopolymer compositions may exhibit opaque properties for applications such as, for example, use as toothbrush bristles to more closely match the look of the plastic tooth bristles people are often accustomed to using.

Moreover, in other embodiments in which no petroleum-based components are included in the biopolymer compositions disclosed herein, it may be preferrable for the biopolymer compositions as well as products fabricated from the biopolymer compositions to be more easily composted, such as basic composting in soil in addition to complying with industrial standards for composting. For example, the biopolymer compositions disclosed herein should meet and/or exceed general industrial composting standards such as ISO 14855-1 and ISO 14855-2 which, among other things, requires at least 90% of the material be converted to carbon dioxide (i.e., CO₂) within one hundred and eighty days (180) and leave no toxic residues. It may be preferrable for the biopolymer compositions disclosed herein to satisfy even higher industrial standards for compostability such as ISO 17088 in which additional requirements beyond those of ISO 14855 demand that no more than 10% of the residue particles are greater than two millimeters in size after ninety days and that there are no adverse effects on plant growth or compost quality. The biopolymer compositions disclosed herein may also be capable of achieving what may be considered to be the “gold standard” for composting by complying with ISO 17556 which requires essentially backyard composting whereby at least 90% of the compositions biodegrade within two years without industrial composting.

The biopolymer compositions disclosed herein exceed current standards for bio-based products such as, for example, by the USDA BioPreferred Program which requires that in order to qualify the products at issue must contain a minimum of 25% biobased content (the BioPreferred program sets varying minimum requirements for the percentage of bio-based content depending on the category; Oral Care Products, for example, require at least 84% bio-based content while the Baby and Kids Oral-Care Products category is set even higher at 93%—these standards may change over time). The biopolymer compositions disclosed herein, on the other hand, are manufactured such that the final composition material is at least double the 25% bio-based standard for the BioPreferred Program and it may be preferrable for the final composition to be 75% or even 100% bio-based. Compliance with such high percentages may be determined in accordance with well-known industry standards such as ASTM D6866 in the United States and ISO 16620 internationally. Both standards measure the presence or absence of carbon 14 levels which will appear in recent biomass materials and be absent in fossil fuel-based materials. As noted above, compliance that achieves a 25% bio-based level or greater under ASTM D6866 will enable the tested products to be labeled as “Certified Biobased Products” under the USDA BioPreferred program, which should be easily achievable with all of the biopolymer compositions disclosed herein as the present disclosed compositions should be able to achieve at least twice the BioPreferred requirement.

It should be noted that the present disclosure focuses on both the compostability and on the percentage of bio-based components within the manufactured compositions as well as the fabricated final or intermediate products, and that compostability and being bio-based are two distinct and entirely different features. In fact, there are certain classes of petroleum-based products that may be fully compostable, at least through industrial composting processes, such as polybutylene adipate terephthalate (PBAT) and polycaprolactone (PCL) which are both biodegradable even in their more common petroleum-based (not bio-based) forms. Thus, products may be compostable even though they are not bio-based. Moreover, the contrary may also be true in that some bio-based products (e.g., 100% bio-based PET) may not be compostable even through industrial composting processes—a very undesirable result.

In this light, it should also be noted that the present disclosure views compostable as a type of sub-category within the world of biodegradable products, whereby biodegradable is considered to be capable of being broken down by microorganisms such as bacteria and fungi without any specified environment or timeframe or promise regarding the quality of residue or presence of heavy metals after biodegrading is complete (or substantially complete). Thus, compostability is considered to be a sub-category of biodegradability in that the process of breaking down the material must be accomplished with specific timeframes, with specific environmental compliance, and such that there remain only safe, non-toxic residues at the end of the process. To that end, the microorganisms that perform the breaking down focus only on their ability to break down the bonds of the material being composted and not on whether the source material is petroleum-based or bio-based material. Accordingly, the compositions disclosed herein and products fabricated therefrom may be manufactured from at least 50% Naturally Occurring components, such that the inclusion of up to 50% petroleum-based components may be included provided the resultant combination is compostable, even though other embodiments disclosed herein may be accomplished with 75% Naturally Occurring components and 25% other-based components, and other embodiments may achieve an entirely Naturally Occurring composition that does not include any petroleum-based components.

The biopolymer compositions and products made therefrom described herein need to exhibit certain mechanical properties that approximate or mimic the mechanical properties of the current lines of compositions and products that are manufactured and fabricated from petroleum-based materials such as petroleum-based polyethylene terephthalate glycol (PETG) and polyurethane (PU) plastics, as well as various combinations of them, that form the basis for a wide variety of products such as orthodontic aligners, retainers, and the like. The resultant materials and products must provide similar flexibility while also providing similar inflexibility and strength to withstand, for example, the grinding that commonly occurs while such products are being used in the mouth to prevent rapid degradation and destruction but at the same time retaining all of the dental properties the products are intended to provide the individual, such as keeping teeth aligned properly.

In the current environment, there are bio versions of some of the traditional petroleum-based materials or compositions, such as bio-PET variants in which the monoethylene glycol (MEG) component may be bio-based and the terephthalic acid (TPA) component may or may not be bio-based and bio-PU products in which the polyol component may be bio-based and the diisocyanate component may or may not be bio-based, but such products often are only 20-30% bio-based (in the case of bio-PET) or 30-70% bio-based (in the case of bio-PU) and are essentially in the experimental stage of development such that they are not commercially viable. In addition, although these experimental products may exhibit the necessary balance between flexibility and inflexibility (or rigidity) for use in dental products such as the aforementioned aligners and retainers, their compositions are likely to render them non-compostable or at least require industrial composting conditions. It may, however, be possible to utilize such materials provided that they could be manufactured with higher levels of bio-based materials having a goal of 100% while at the same time developing a combination of such materials with appropriate additional components (e.g., bio-based plasticizers, impact modifiers, and/or fillers) that enhance the compostability of the final composition.

Another potential option for replacing petroleum-based plastics with compositions of 100% Naturally Occurring components is polylactic acid (PLA), which is a 100% bio-based, biodegradable plastic formed from natural fermentable sugars such as corn, sugarcane, cassava root, sugar beets, and the like. One of the most common applications of PLA is in 3D printing, where spools of multi-colored PLA filament can be fed into 3D printers with relative ease. Some of the properties that make PLA such a unique fit for 3D printing, however, are impediments to PLA's use in dental applications. For example, anyone picking up a spool of PLA filament for a 3D printer will quickly notice how rigid and brittle the material is and how difficult it is to bend and form because of an overall lack of flexibility which makes PLA a poor candidate for dental applications such as aligners and retainers. PLA also exhibits deformation at high temperatures which are often utilized in dental applications to soften, for example, aligners, retainers, and mouth guards, during the fitting process. Additional issues with PLA is that while it is generally biodegradable, it is not, by itself, soil compostable requiring treatment at an industrial composting facility in order to be successfully broken down due to the high heat and controlled humidity required to successfully complete the process of breaking down the PLA.

As set forth above, some embodiments of the present invention are able to satisfy various requirements that are otherwise unachievable collectively with current materials and composition offerings, such as: (i) using 100% Naturally-Occurring components while utilizing 0% petroleum-based components; (ii) being soil compostable without requiring industrial composting; (iii) being durable to last at least three to six months, if not a year, during normal daily use in an oral environment without showing significant signs of degradation or significant changes to the mechanical properties (e.g., holding the tooth patterns and alignment during that period of time); (iv) exhibiting mechanical properties suitable for dental/oral applications such as orthodontic aligners, retainers, night guards, as well as other dental applications such as toothbrush bristles (which are traditionally formed from 100% or primarily petroleum-based components or compositions)—including: high degrees of material uniformity, flexibility/inflexibility that enables fitting while also retaining the fitting characteristics throughout the useful life of the end product, thermal stability (such that when heat is used as part of the fitting process the compositions and end product remains stable but flexible for the fitting process to succeed). To that end, the compositions of the present invention need to be capable of being extruded or injection-molded as part of the fabrication process from pellets, sheets, and the like into finished end products as an initial step, while also being capable of withstanding additional processing through additional rapid and intense heat cycle that may include stretching and shaping processes in order to complete the manufacturing process into orthodontic aligners or retainers, etc.

Accordingly, some embodiments herein will need to retain the desired mechanical characteristics through multiple manufacturing process steps beginning with raw materials, going through injection molding or extrusion to form interim products such as sheets for fabrication, followed by the fabrication into finished products which will require additional thermoforming processing steps. These process steps will require the materials and compositions to undergo, in most instances rapid heating to at least, for example, the product's glass transition temperature—the point at which the material shifts from a hard/glassy state to a soft/rubbery state, and in which certain products may require being heated further to a molten/moldable state. One of the potential issues with this processing is that cycling a polymer past its glass transition temperature or into a molten state and then back has the potential to change the material properties of the compositions/products. Other potential issues may arise due to the rapid heating/cooling process (e.g., completing the process in under a minute or even under 30 seconds) versus a slower more gradual heating/cooling cycle which may cause the mechanical characteristics to change in an undesirable way.

In some embodiments, as described above, the extreme heating/cooling process only results in interim products such as sheets of manufactured material. In order to fabricate the final products, which may or may not be specifically custom designed and manufactured for each individual patient, the processed sheets need to be able to withstand rapid and often violent stretching under pressure (which may be positive and/or negative pressure depending on the design) over a model to form the final end product. The rapid stretching process may cause polymers to reorient themselves or even break as compared to their pre-stretching state, which can introduce significant changes to the material properties of the final product as compared to the interim products resulting in potential undesired weakness and/or durability. Accordingly, the mechanical characteristic during the transition from raw materials to the interim products (i.e., sheets) should be such that the interim products exhibit higher levels of material uniformity and heat stability than standard polymer products (regardless of whether those products are made from Naturally Occurring or petroleum-based components). Persons of ordinary skill in the art will appreciate that the mechanical characteristics for dental products, for example, must fall within a much narrower range of tolerance than, for example, manufacturing plastic food containers and the like.

In some embodiments PLA may be utilized as a base material given that it is 100% bio-based and that it can be composted even though industrial composting is required. Given the issues described above regarding the excess rigidity, however, the compositions, interim products and end products could not be fabricated entirely from PLA. In order to make the PLA polymer material softer a plasticizer may be added to provide the resultant combined material with more flexibility than PLA alone. If it is desired to achieve compositions including 100% Naturally Occurring components as a solution, as described above, the plasticizer would also need to be 100% Naturally-Occurring, such as, without limitation, palm oil, sunflower oil, glycerol, and low and medium molecular weight polyethylene glycols. It may also be advantageous to form blends from two or more of these materials to optimize the positive characteristics from each in the final product. Regarding the blends, it may be advantageous to blend them together in a simple manner similar to throwing them into a mixing bowl. Alternatively, it may be advantageous to put the materials to be blended through a mixing and extrusion process that could assist in the blending.

In some embodiments, given the processing described herein, where compositions are manufactured into interim products through injection molding and/or extrusion and the final products are then formed through severe plastic deformation in a subsequent thermoforming process, it may be important for the products to exhibit a high degree of shape memory—the ability of the product to be deformed through force, hold its shape when the force is removed, and recover its original shape only when exposed to certain intense non-normal external stimulus such as extreme heat, extreme light (such as specific frequencies), or electric fields. Some embodiments may also need to exhibit a high degree of elastic recovery—where the product returns to its original form by simply removing the external force causing the deformation. One example of the desired elastic recovery effect is a dental aligner which is individually designed for where the teeth are intended to be moved such that when placed in the patient's mouth are deformed to the current state of the teeth where the aligner (having a high degree of elastic recovery) constantly works to return to its original form at which point the teeth would have been moved to the desired positioning within the mouth.

In other embodiments, adjustments to the mechanical properties may be accomplished by taking the base PLA material, adding plasticizer as described above, but then adding one or more fillers to balance the stiffness given that the introduction of the plasticizer adds in flexibility. For fillers, various Naturally Occurring materials may be utilized such as, without limitation, talc, calcium, carbonate, dolomite, magnesium hydroxide, aluminum silicate, silica, Kaolin clay, and/or various starches. Depending on the desired mechanical properties, the fillers may be added as a percentage by weight, such as talc at between 5-25% by weight, calcium carbonate at between 2-30% by weight, and Kaolin clay at between 7-22% by weight. The fillers provide varying levels of increased stiffness and impact strength due to the rigidity of the fillers themselves, but care must be taken due to the likelihood, particularly at higher percentages, of reducing tensile strength while introducing a level of brittleness that may result in breakage during deformation of the final products.

In even further embodiments, it may be advantageous to introduce polyhydroxyalkanoates (PHAs) into the PLA to improve compostability at least because PHAs are 100% bio-based polyesters that can act like petroleum-based products like polypropylene and polyethylene but are completely biodegradable materials in soil and through marine composting. In addition, PHAs tend to be more ductile and therefore less brittle while also providing increased flexibility. Moreover, depending on the specific chemical structure of the PHAs utilized, PHAs can provide rigidity or flexibility depending on the length of the hydroxy fatty acid carbon chains in their associated monomers. PHA's are categorized depending on the length of those carbon chains as short chain (scl-PHA) when there are 3-5 carbon atoms, medium chain (mcl-PHA) when there are 6-14 carbon atoms, and long chain (lcl-PHA) when there are greater than 14 carbon atoms (long chain PHAs are relatively rare at this time). The varying number of carbon atoms has a direct correlation to the level of crystallinity of the PHA such that the lower the number of carbon atoms, the higher the level of crystallinity (e.g., long PHA can be almost amorphous), as well as the melting temperature of the PHA where the lower the number of carbons the higher the melting temperature.

For example, polyhydroxyhexanoate (PHHX) is one category of PHAs having a medium side chain that provides very flexible and elastic end products so it may used in medical products such as sutures. That excessive elasticity resulting from the medium side chain, however, may render PHHX as not being suitable for the dental products disclosed herein. PHAs may also provide improved barrier properties-how well a material resists penetration by gas and/or moisture-which can provide improved useful life for products that are intended to be used in the high moisture environment of the mouth. In some embodiments it may be beneficial to utilize small chain PHAs while in other embodiments medium chain PHAs may provide more beneficial characteristics, and it may be useful to utilize long chain PHAs as they become more readily available in the marketplace. In other embodiments, it may be beneficial to include a combination of various different length PHA components, such as a mixture of small and medium chain PHAs or small and long chain PHAs or all three length PHAs, etc., depending on the specific characteristics desired.

Another feature of PHAs that varies depending on the length of the carbon atom chain relates to transparency. Shorter carbon atom chains tend to exhibit opaque-like transparency while long carbon chains tend to exhibit high degrees of transparency. It may, for example, be beneficial to utilize PHAs having a refractive index similar to PLAs so that the two materials blended together may provide a more consistent level of transparency throughout the interim and finished products. Thus it may be possible to achieve a high level of transparency such that the interim and final products can be achieved with almost entirely transparent versions similar to what current petroleum-based products look like today.

It may be further advantageous in other embodiments to add impact modifiers to the initial composition to provide improvements in ductility (overall strength) and elastic recovery (the ability to return to the original form upon removal of a force causing deformation). The impact modifiers may include, for example, without limitation, polybutylene succinate (PBS), polybutylene succinate adipate (PBSA), polybutylene adipate terephthalate (PBAT) and polycaprolactone (PCL). It may be advantageous to include impact modifiers in the range of between 0.5-50% by weight or more narrowly to between 5-45% by weight. It does appear, however, that the combinations of PBS and PLA (without the addition of PHA), and PBAT and PLA (without the addition of PHA) are too prone to cracking while failing to provide sufficient flexibility, and that the combination of PBAT and PLA blended with PHA provided excess flexibility.

Some embodiments that exhibit improved flexibility, ductility (strength) and elastic recovery result from the combinations of PBS as the impact modifier added to the blend of PLA with PHA, as well as an impact modifier combination of PBS and PBAT with the blend of PLA with PHA. It may also be advantageous to also utilize one or more of the fillers previously described to assist in overcoming any resistance of PBS, PBAT and/or PLA from blending with the PHA. The use of fillers as a component of the composition mix tends to assist in a more uniform transfer of heat throughout the mixture while at the same time reducing the likelihood that other components may begin clumping as they begin to melt at somewhat different melting temperatures, which helps increase the uniformity of the final blend as well as the final extruded materials. To that end, embodiments disclosed herein may include, for example, PLA at a range of 0-60% by weight, PHA at a range of 0-55% by weight, PBS at a range of 0-25% by weight, PBAT at a range of 0-5% by weight and fillers at a range of 0-10% by weight, in which at least three of these listed components are included at percentages above 0%.

As noted above, the compositions described herein may be fabricated into films or sheets as interim products which themselves can be fabricated into end products by “molding” which, when the term is applied to a film or sheet product, typically means “thermoforming”, but which may include other methods of transforming an interim film or sheet product into an end product. When applied to the composition prior to its being fabricated into films or sheets as interim products, the term “molding” collectively includes any of the following processes: thermoforming, extrusion blow molding, injection blow molding or injection stretch blow molding, blow film molding or any other extrusion process. The compositions described herein may be fabricated into end products through molding processes with or without first fabricating them into films or sheets as interim products. The end products, as described above, may be manufactured to include at least 75% Naturally Occurring components, and in some embodiments shall include 100% Naturally Occurring components and 0% petroleum-based components. The end products, as described above, shall be compostable, and in some embodiments, the end products shall be soil compostable. The compostable end products described herein include a wide range of products including, without limitation, orthodontic aligners, retainers, night guards, mouth guards, toothbrush bristles, etc.

In some embodiments, manufacturing of the compositions into the interim products may be accomplished by creating a dry mix of all of the components using industrial mixing devices such as a high-speed mixing unit with nylon mixing handles. During the mixing process care should be taken to avoid a buildup of static current that may cause certain components to stick to the side walls of the mixing unit and therefore not be incorporated into the mixture properly. After sufficient mixing, the mixture may be preheated in a unit that removes moisture and humidity from the mixture such as a pre-drying oven. Once moisture content has been reduced sufficiently, the mix is then introduced to a sheet extrusion line where, under controlled heat, the mix is extruded into a sheet which is then reheated before being laminated.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the scope of the present invention.

What is claimed is:

1. A compostable composition containing at least 75% of Naturally Occurring components comprising:
a base material comprising at least one of:
a bio-based polylactic acid (PLA) polymer;
a bio-based polyethylene terephthalate glycol (PETG) polymer;
a bio-based polyurethane (PU) polymer; and
a bio-based polyhydroxyalkanoates (PHA) polymer.

2. The compostable composition of claim 1 further comprising an impact modifier comprising at least one of:
a polybutylene succinate (PBS) polymer; and
a polybutylene adipate terephthalate (PBAT) polymer.

3. The compostable composition of claim 1 further comprising:
a Naturally Occurring filler.

4. The compostable composition of claim 2 further comprising:
a Naturally Occurring filler.

5. The compostable composition of claim 1, wherein said base material comprises up to 90% by weight of said composition.

6. The compostable composition of claim 2, wherein said impact modifier comprises up to 30% by weight of said composition.

7. The compostable composition of claim 3, wherein said Naturally Occurring filler comprises up to 15% by weight of said composition.

8. The compostable composition of claim 4, wherein said Naturally Occurring filler comprises up to 10% by weight of said composition.

9. The compostable composition of claim 3, wherein said Naturally Occurring filler comprises at least one of:
talc, calcium carbonate, dolomite, magnesium hydroxide, aluminum silicate, silica, cassava starches, sweet potato starches, arrowroot starches, and Kaolin clay.

10. The compostable composition of claim 4, wherein said Naturally Occurring filler comprises at least one of:
talc, calcium carbonate, dolomite, magnesium hydroxide, aluminum silicate, silica, cassava starches, sweet potato starches, arrowroot starches, and Kaolin clay.

11. The composition of claim 1, wherein said composition is soil compostable.

12. The composition of claim 1, wherein said PHA comprises one of:
a short chain PHA;
a medium chain PHA; and
a long chain PHA.

13. The composition of claim 1, wherein said PHA comprises a blend of at least two of:
a short chain PHA, a medium chain PHA, and a long chain PHA.

14. An extruded or injection molded film or sheet formed from a composition of at least 75% Naturally Occurring components comprising:
a base material comprising at least one of:
a bio-based polylactic acid (PLA) polymer;
a bio-based polyethylene terephthalate glycol (PETG) polymer;
a bio-based polyurethane (PU) polymer; and
a bio-based polyhydroxyalkanoates (PHA) polymer;
wherein said film or sheet is a thermoformable, monolayer, or multilayer film having a thickness of 300 microns to 5000 microns.

15. The film or sheet of claim 14 further comprising an impact modifier comprising at least one of:
a polybutylene succinate (PBS) polymer; and
a polybutylene adipate terephthalate (PBAT) polymer.

16. The film or sheet of claim 14 further comprising:
a Naturally Occurring filler.

17. The film of sheet of claim 14 wherein said film or sheet is soil compostable.

18. The film or sheet of claim 14, wherein said film or sheet is compostable, and flexible having a tensile stress of 35 to 85 MPa and flexural modulus of elasticity of 1200 to 3500 MPa.

19. The film or sheet of claim 14, wherein said film or sheet is clear, having a light transmission greater than 80% and haze of 0.3% to 1.2%.

20. A compostable molded medical or dental appliance or article formed from at least 75% Naturally Occurring components comprising:
a base material comprising at least one of:
a bio-based polylactic acid (PLA) polymer;
a bio-based polyethylene terephthalate glycol (PETG) polymer;
a bio-based polyurethane (PU) polymer; and
a bio-based polyhydroxyalkanoates (PHA) polymer, wherein said medical or dental appliance or article has a thickness of 0.001 mm to 20 mm.

21. The compostable molded appliance or article of claim 20 further comprising an impact modifier comprising at least one of:
a polybutylene succinate (PBS) polymer; and
a polybutylene adipate terephthalate (PBAT) polymer.

22. The compostable molded appliance or article of claim 20 further comprising:
a Naturally Occurring filler.

23. The compostable molded appliance or article of claim 20, wherein said appliance or article is compostable, having a tensile stress of 20 to 85 MPa, flexural modulus of elasticity of 650 to 4500 MPa, and a shore hardness ranging A50 to D80.

24. The compostable molded appliance or article of claim 20, wherein said appliance or article has a light transmission from 50% to 93% and haze of 0.3% to 1.2%.

25. The compostable molded appliance or article of claim 20, wherein said appliance or article is soil compostable.
